(19) United States
(12) Patent Application Publication
(10) Pub. No.: US 2003/0078788 A1
(43) Pub. Date: Apr. 24, 2003

(54) System and method for sales leads prospecting automation

(76) Inventors: Lester Sussman, Bethesda, MD (US); David Dilldine, Reston, VA (US)

Correspondence Address: LESTER SUSSMAN, 9213 BULLS RUN PARKWAY, BETHESDA, MD, 20817-2403, US

(21) Appl. No.: 09/981,600

(22) Filed: Oct. 18, 2001

(51) Int. Cl. G06F 17/60

(52) U.S. Cl. 705/1

(57) ABSTRACT

This invention provides a method and system that extracts and collates electronic sales prospect data from multiple selectable data sources, which can be downloaded to mobile computing devices and desktop computers. In business, finding prospects that will lead to new customers has been and continues to be the most critical and the most challenging stage in the sales process. The sales prospect data includes GPS location coordinates that assist in pinpointing prospects within a specific territorial region and helps to navigate to the specific prospective customer locations. Other pertinent data includes contact information about decision makers at the prospective customer's location. The invention creates a centralized collated database that covers the salesperson's target market, based on parameters that a salesperson has specified. The database can be queried securely either on a LAN, a wireless network or the Internet. Query responses can be received in-hand via fax, telephony-audio or downloaded to a mobile computing device.

### BACKGROUND OF THE INVENTION

In business, finding prospects that will lead to new customers has been and continues to be the most critical and the most challenging stage in the sales process. An article titled “Successful agents share some key insights” in the Sep. 10, 2001 issue of the National Underwriter emphasizes the fact that most salespeople regard prospecting as the most difficult part of the business. This invention provides readily usable electronic prospect information and does it within the normal workflow of the sale process.

The Sales Cycle in field sales is a method consisting of a series of steps in the course of acquiring new customers. The steps when viewed in the aggregate of an entire sales force are very predicable. For example, in the life insurance industry the average established agent will find that if he meets ten prospects face-to-face, three of them will give him enough information to submit a proposal and of those, one will become a client within that sales cycle. The 10-3-1 ratio is based on hundreds of thousands of sales activity records kept for the last forty years. Table 1 illustrates the impact of increasing the number of prospects and resulting sales appointments based on the 10-3-1 ratio. Note that the costs associated with each appointment increases proportionately, i.e. travel costs and time. The invention addresses these costs by providing information to the salesperson to reduce the amount of travel and time that is normally experienced. This information allows the salesperson to set up initial appointments within close proximity of each other, thereby reducing travel costs and increasing personal productivity.

TABLE 1

| | | | | Additional |
|---|---|---|---|---|
| | | Additional | | Annual |
| | Additional | Annual | Additional | Company |
| Additional | Annual | Proposals | Annual | Sales based |
| Weekly | Appointments | (Appoint- | Sales | on 500 |
| Appointments | (Weekly × 52) | ments/3) | (Proposals/3) | Salespeople |
| 1 | 52 | 15 | 5 | 250 |
| 5 | 260 | 78 | 26 | 13,000 |
| 10 | 520 | 156 | 52 | 26,000 |

There are three broad categories of activity within the Sales Cycle, i.e. the Pre-Sale, the Sale and the Post-Sale. Each of these steps/stages is now described with the applicable phases/activities that a salesperson does in each.

### Pre-Sale (Prospect)

Generally the first defined step in the Sales Cycle is summarized as the Prospect stage. Activities or phases in this stage include, market targeting, lead generation, and lead qualification. For example, a purchased list of names, addresses and phones numbers of individuals making over $100,000 a year, or business with 10 to 100 employees could be defined as a qualified prospect list.

### Sale

The initial “touch”, e.g. mailing of brochures, phone calls or face-to-face, is the first phase in the Sale step of the cycle. Additional qualifying is done at this time and if appropriate, a fact-finding Interview is scheduled as the next phase in the Sales Cycle.

Following the Interview phase comes a period where information is shared, rapport and credibility is built, understandings are confirmed and a relationship is established.

If all goes well the Presentation phase begins. A proposal is presented in some appropriate format to the potential customer, e.g. a slide presentation, brochures, etc.. In this step questions and objections are addressed and overcome, requirements are defined, a final proposal is developed and trial closes are begun.

Then comes the Close(s). A contract of business is agreed upon. There can be additional phases to this stage depending on the complexity of the contracting process.

### Post-Sale

Next comes the Post-Sale step. This step can include additional phases as well. For example, in the technology sector there is the Implementation or Installation phase. The time frame here can vary greatly. The Post-Sale step can include the After-Sale service phase.

### After-Sale

During the After-Sale service step the Sales Cycle is continues with additional sales.

### Sales Lead Generation (Prospecting) Overview

An overview of the Sales Lead generation process is now described. Lead generation, i.e. prospecting is where it all starts in the Sales Cycle. Sales are generally considered a “numbers game”. The first facet of the “numbers game”, is to bring enough qualified prospects into the “sales funnel” (i.e. as mentioned previously there's generally a 10-3-1 ratio in the sales cycle) and that will get the salesperson in front of enough prospects to find those that are willing and ready to buy. The second facet is do a good job up front in qualifying prospects so time, money and energy is not wasted on unqualified prospects moving through the sales cycle. In other words, narrow the “sales funnel”. The balance between quantity and quality is critical, i.e. it defines the salesperson's productivity during the Pre-Sale step.

An organization has two options for generating leads, have the salespeople do it or have it done somewhere else, i.e. outsourced.

When salespeople generate the leads the sales funnel is narrowed on the quality side of the equation. However, there are built in limitations on the amount of time and money that can be spent on this stage of the Sales Cycle by the salesperson. Revenue is only generated at the end of the cycle and expenses are generated at all other stages. Survival of the organization and sales person depends on a balance in the activity through the cycle. So the inevitable problem here is the funnel is often too narrow, i.e. insufficient qualified leads are generated. The good news is that the sales funnel is narrowed to qualified prospects because the communications, especially if face-to-face, is much more effective for qualifying the prospects and establishing a relationship.

The other option is having the leads and initial appointments setup by a combination of mailings and telemarketers. The downside to this is the cost and the quality of the prospect. Whether it is done outside or inside a company the costs are significant.

### OBJECTIVES OF THE PRESENT INVENTION

It is an objective of the invention to provide a method and system to collate into a central, standardized database, various information sources pertinent to generating sales leads.

It is another objective of the invention to provide a method whereby the sales leads collated in the central database can be downloaded into a portable computing device.

It is a further objective of the invention to provide a GPS location system to accurately pinpoint and travel to various sales leads locations.

Another objective of the invention is to provide a method and system to access remotely the collated sales leads database and to download further sales leads.

### BRIEF DESCRIPTION OF THE DRAWINGS

FIG. 1 is a schematic of the preferred invention's depiction of the Sales Cycle.

FIG. 2 is a schematic of the preferred invention's embodiment of the sales force leads prospecting automation system.

### DETAILED DESCRIPTION OF THE INVENTION

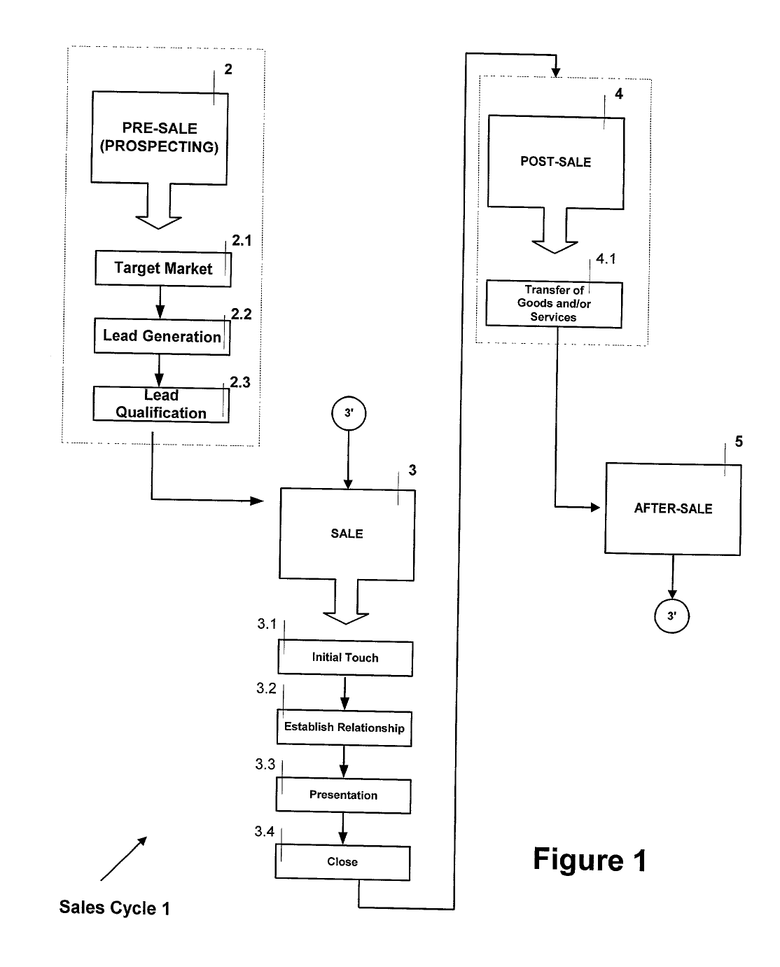

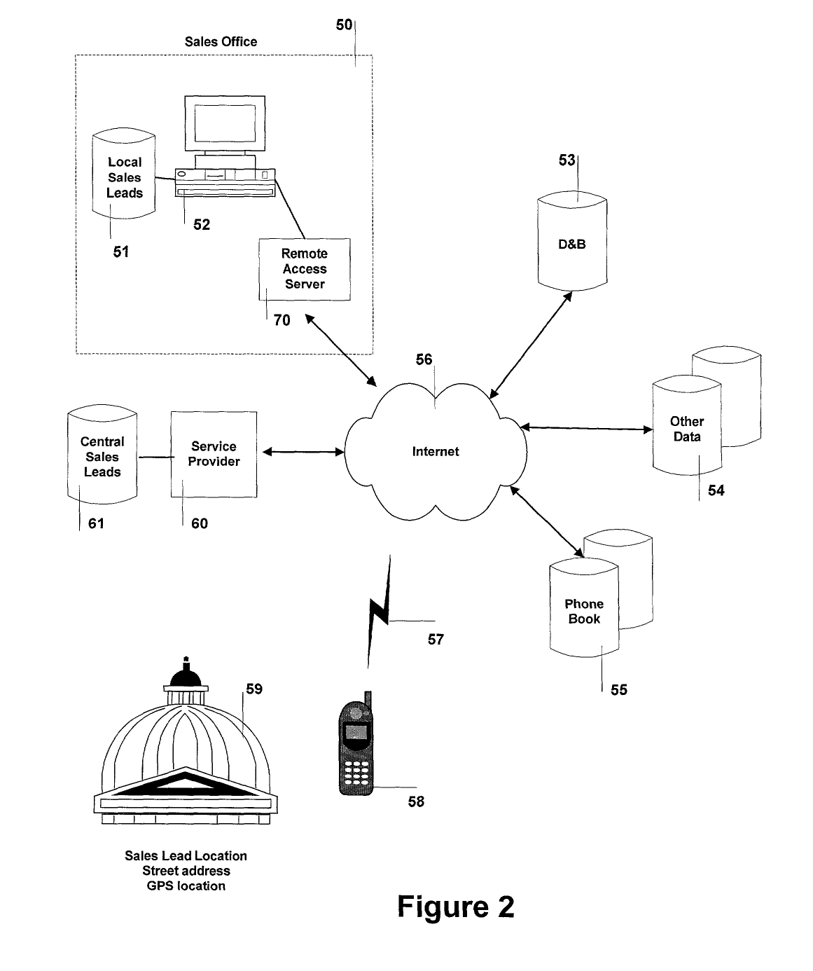

With reference to FIG. 2 the preferred embodiment of the invention consists implementing the various steps in the Sales Cycle 1 as described in the Background of the Invention and depicted in FIG. 1.

Before describing the detailed description of the preferred embodiment of the invention, we first need to consider a few general concepts that the invention uses.

An overview of various cryptography technologies that are used by the preferred embodiment are now discussed.

### Cryptography for Verification, Integrity and Confidentiality

Two key technologies that the preferred embodiment of the invention uses is public key and conventional cryptography to ensure three things:

(1) The transaction partner, i.e. the salesperson is who she claims to be and that the database (i.e. at the Sales Office 50 and /or at the Service Provider 60) that the salesperson has logged onto is not a counterfeit database.

(2) Confidentiality of the data transmitted between the transaction partners.

(3) The data has not been altered during transmission.

Various implementations of cryptography are used in the invention's preferred embodiment, such as Netscape's Secure Socket Layer (SSL), Phil Zimmerman's Pretty Good Privacy (PGP), Microsoft's Secure Electronic Transactions (SET), etc. All of these methods use a combination of public key and conventional cryptography.

Conventional cryptography is also called secret key or symmetric key cryptography. The Data Encryption Standard (DES), Triple Des and Message Digest 5 (MD5) are examples of symmetric key cryptography. MD5 is described in further detail in the Internet Engineering Task Force's (IETF) RFC 1321. Use of secret keys to encrypt data is much faster than public key encryption, but the problem of using symmetric keys is the safe distribution of the keys between transaction partners. This key distribution is solved using public key cryptography.

Public key cryptography is an asymmetric method that uses a pair of keys for encryption: a public key that encrypts data and a private key (i.e. secret key) that decrypts the data. The public key is openly distributed. The key's owner keeps the private key secret. The secret key cannot readily be derived from the public key.

The above methods of cryptography are not described in detail in this invention. Excellent references are available that were used to devise the preferred embodiment of the invention. These references include:

“How SSL Works” by Netscape.

“Internet Cryptography” by Richard E. Smith.

“Applied Cryptography” by Bruce Schneier.

The Internet Engineering Task Force RFC library.

A brief description follows of the various cryptography implementations that the invention's preferred embodiment uses.

PGP uses a combination of public-key and conventional encryption to provide security services for electronic mail messages and data files. These services include confidentiality and digital signature. The IETF has a number of RFCs on PGP, which is also known as OpenPGP, e.g. RFC 1991 (“PGP Message Exchange Formats”) and RFC 2440 (“Open Message Format”).

Some background on PGP now follows. When plaintext is encrypted with PGP, PGP first compresses the plaintext. Data compression saves data transmission time and device memory space and, more importantly, strengthens cryptographic security. Most cryptanalysis techniques exploit patterns found in the plaintext to decode the cipher. Compression reduces these patterns in the plaintext, thereby greatly enhancing resistance to cryptanalysis. PGP then creates a session key, which is a one-time-only secret key. This key is a random number generated from the random movements, e.g. of a computer's mouse and the keystrokes that are typed. This session key works with a very secure, fast conventional encryption algorithm to encrypt the plaintext; the result is ciphertext. Once the data is encrypted, the session key is then encrypted to the recipient's public key. This public key-encrypted session key is transmitted along with the ciphertext to the recipient.

Decryption works in the reverse. The recipient's copy of PGP uses her private key to recover the temporary session key, which PGP then uses to decrypt the conventionally encrypted ciphertext.

The combination of the two encryption methods combines the convenience of public key encryption with the speed of conventional encryption. Conventional encryption is about a thousand times faster than public key encryption. Public key encryption in turn provides a solution to key distribution and data transmission issues. Used together, performance and key distributions are improved without any sacrifice in security.

A cryptographic key is a value that works with a cryptographic algorithm to produce a specific ciphertext. Keys are basically very large numbers. Key size is measured in bits; the number representing a 1024-bit key is computationally very large. In public key cryptography, the bigger the key, the more secure the ciphertext. However, public key size and conventional cryptography's secret key size are totally unrelated. A conventional 80-bit key has the equivalent strength of a 1024-bit public key. A conventional 128-bit key is equivalent to a 3000-bit public key. Again, the bigger the key, the more secure, but the algorithms used for each type of cryptography are very different. While the public and private keys are mathematically related, it's very difficult to derive the private key given only the public key; however, deriving the private key is always possible given enough time and computing power. This makes it very important to pick keys of the right size; large enough to be secure, but small enough to be applied fairly quickly. Larger keys will be cryptographically secure for a longer period of time. Keys are stored in encrypted form. PGP stores the keys in two files on the user's computing device: one for public keys and one for private keys. These files are called keyrings. If the private keyring is lost, the user will be unable to decrypt any information encrypted to keys on that ring. As with any user generated electronic file, it is advisable for the user to back up these PGP keyrings to floppy disk, Zip disk, or any other appropriate electronic media.

The invention's preferred embodiment uses PGP to create digital certificates. Digital certificates (certificates) allow the recipient of information to verify the authenticity of the information's origin. In other words, digital certificates provide authentication and data integrity. Non-repudiation is also provided. A digital certificate consists of three components:

A public key

Certificate information, e.g. salesperson's name, logon user ID, etc.

One or more digital signatures.

The purpose of a digital signature on a certificate is to attest that the certificate information has been electronically notarized by some other person or entity, e.g. from a trusted third party such as a Certificate Authority, e.g. VeriSign. The digital signature does not validate the authenticity of the whole certificate; it only vouches that the signed identity information goes along with the public key. PGP uses a one-way hash function to create a digital signature. Valid hash functions used in the IETF's OpenPGP include MD2, MD5, SHA-1 and RIPEMD-160. PGP uses a hash function on the certificate information that is being signed. This generates a fixed length data item known as a message digest. Any alteration to the certificate information results in a totally different message digest (digest), i.e. data integrity is established. PGP then uses the message digest and the private key to create the digital signature. Upon receipt of the certificate, the recipient uses PGP to re-compute the message digest, thus verifying the signature. As long as a secure hash function is used, there is no way to take someone's signature from one document and attach it to another, or to alter a signed message in any way. The slightest change in a signed document will cause the digital signature verification process to fail.

In June 2000 the US Congress passed an act (the Electronic Signatures in Global and National Commerce Act) to legally accept digital signatures in electronic transactions. In July 2000 President Clinton signed the Electronic Signatures in Global and National Commerce Act.

The preferred embodiment uses various trusted parties to create digital certificates. Various formats exist for digital certificates including PGP and the International Telecommunications Union's (ITU) X.509 certificates. The preferred embodiment of the invention uses PGP certificates, but could easily use X.509 certificates, or other certificate formats. The format of a PGP certificate is as follows:

The PGP version number—identifies which version of PGP was used to create the key associated with the certificate.

The certificate holder's public key—public portion of the holder's asymmetric key pair together with the algorithm of the key: RSA, Diffie-Hellman, or DSA.

The certificate holder's information—e.g. salesperson's name, logon user ID, etc.

The digital signature of the certificate owner—uses the private key of the certificate holder's public key.

The certificate's validity period—start date and expiration date.

The preferred symmetric key method for the key—e.g. Triple-DES, CAST, or IDEA.

SSL has been universally accepted on the Internet 56 for authenticated and encrypted communication between transaction parties, e.g. client computers 52 and a service providers' 60 server computers. These capabilities address fundamental concerns about secure communication over the Internet 56 and other TCP/IP networks such as X.25, etc.:

SSL server authentication allows a user to confirm a server's identity. SSL-enabled client software running on a computing device can use standard techniques of public-key cryptography to check that a server's certificate and public ID are valid and have been issued by a certificate authority (CA) listed in the client's list of trusted CAs.

SSL client authentication allows a server (e.g. at the Service Provider 60, and at the Sales Office 50) to confirm a user's identity. Using the same techniques as those used for server authentication, SSL-enabled server software can check that a client's certificate and public ID are valid and have been issued by a certificate authority listed in the server's list of trusted CAs.

An encrypted SSL connection requires that all information sent between a client and a server to be encrypted by the sending software and decrypted by the receiving software, thus providing a high degree of confidentiality. Confidentiality is important for both parties to any private transaction. In addition, all data sent over an encrypted SSL connection is protected with a mechanism for detecting tampering, that is for automatically determining whether the data has been altered in transit.

For more details on SSL, the Netscape web site provides a wealth of information at http://developer.netscape.com/docs/manuals/security.

TLS (Transport Layer Security) is a new and evolving Internet Engineering Task Force (IETF) standard and is based on SSL. TLS is defined in RFC 2818 (“HTTP Over TLS”). This invention does not exclude the use of TLS in place of SSL when TLS is adopted on the Internet 56.

### Data Source Integration

First, a general note about the preferred embodiment of information provided by the Service Provider 60 to create either a Local Sales Leads 51 database, or a Central Sales Leads 61 database. The salesperson can specify which sources of information she wants the Service Provider 60 to access. For example, in order to keep her costs down, the salesperson may request that only various Phone Books 55 need to be used. On the other hand, the salesperson could select that the Service Provider 60 collates information from multiple sources of data, e.g. Phone Books 55, Harris InfoSource, InfoUSA.com, Dunn & Bradstreet (D&B 53), etc. Obviously the more sources of information that the salesperson uses, the more complex is the task for the Service Provider 60, and hence the longer it will take to create the pertinent sales lead database.

We now consider how information is obtained by the Service Provider 60 and hence provided to the salesperson, from these various sources of data.

The Service Provider 60 automates the process of collating information obtained from various sources, e.g. D&B 53, Phone Books 55 (e.g. the YellowPages and Business White Pages, etc.) and Other Data 54 by programmatically interfacing with the data source computers via the Internet 56.

Today D&B 53 provides an Application Programming Interface (API) called D&B Global Access Toolkit (http://globalaccess.dnb.com), which is an example of a programmatic means that the Service Provider 60 uses in the preferred embodiment to access information in order to create either of the Sales Leads databases 51 and 61 based on prospecting search criteria specified by the salesperson. A note about integrating information extracted from electronic Phone Books 55: the means to integrate with this data is specified in Sussman's U.S. Pat. No. 5,483,586 the “Electronic On-Line Subscriber Telephone Directory” when used in conjunction with standard software engineering practices. For example, using APIs is common practice to integrate computer-to-computer communications. The current invention relies on this software methodology to implement computer-to-computer interaction. Where appropriate other software engineering practices that enable computer-to-computer interaction are also adopted by the present invention, e.g. CORBA, Java Remote Method Invocation (RMI), Microsoft's Net architecture, etc.

Note that even though the preferred embodiment has the Service Provider 60 using the Internet 56 to access the various databases, the Service Provider 60 could as easily use a private network to access these databases, e.g. via an X.25 network (not shown in FIG. 2).

We now consider the type of information that the Service Provider 60 collates (i.e. Company Data) into a sales leads database.

### Company Data

Information about a company in the Target Market 2.1 is critical to the Sales Cycle 1. Various companies provide various data about companies. For example, InfoUSA.com provides the salesperson the ability to prospect for information by various means, such as illustrated in Table 2 (excluding GPS Longitude and Latitude).

TABLE 2
Sales Prospect Information

| Prospect Key | | Prospect Information |
|---|---|---|
| 1) | Location | ZIP code, neighborhood, city, county, |
| | | state, [GPS Latitude and Longitude], |
| | | electronic-mail addresses, web |
| | | address and other Internet addresses, |
| | | etc. |
| 2) | Type of Business | Yellow Page heading, Major Industry |
| | | Group, SIC (Standard Industry |
| | | Classification) Code or Professions. |
| 3) | Business Size | Number of employees and sales |
| | | volume |
| 4) | Credit Rating | Indicator of probable ability to pay. |
| 5) | Location Type | HQ, Branch, etc. |
| 6) | Phone and Fax Numbers | Primary businesses contact numbers. |
| 7) | Key Decision Makers/ | People that are important to facilitate |
| | Executives | a sales decision. |

InfoUSA.com collates its information by accessing the following sources of information;

Over 5,000 Yellow Page and Business White Page directories

Leading business magazines and newspapers

Companies' annual reports

10Ks and other SEC filings

Postal service information, etc.

The most critical information that a salesperson is seeking in the Sales Cycle 1, are companies pertinent to her Target Market 2.1, and within each of the companies pertinent people who are decision makers who can assist in the Close 3.4 of a Sale 3. This process is the Lead Generation 2.2 phase. Table 2 illustrates the information that a salesperson will use to target specific companies for a Sale 3. The preferred embodiment's Service Provider 60 accesses the various sources of information and creates a tailored database for the salesperson. Generally the salesperson would specify the Type of Business that she is interested in. A database similar to Table 2 is built for the salesperson by the Service Provider 60, collating information from various sources.

Tables 3 and 4 illustrate the prospecting information that various sources of information provide about companies. Comparing these tables to Table 2, it can be seen that “extraneous” data resides in these tables. For example, in Table 3, the Stock Ticker, Employment Change and the Harris ID is data is not particularly useful to a salesperson. The preferred embodiment filters out information that Table 2 does not list, i.e. a common base of prospecting information is presented to the salesperson, who can then sift through the information in a standard way. Today it is somewhat confusing and hence time consuming to a salesperson when she accesses the various data sources independently.

TABLE 3
Harris InfoSource's Company Data

| Harris | |
|---|---|
| InfoSource | |
| Data Field | Harris Data |
| Harris ID | 6013460 |
| Company | EMS Technologies Inc. |
| Address | PO Box 7700 |
| | Norcross, GA 30091-7700 |
| Location | 660 Engineering Dr. |
| | Norcross, GA 30092-2821 |
| County | Gwinnett |
| Phone | (770) 263-9200 |
| Fax | (770) 263-9200 |
| 800 Number | Not for public use |
| Web address | www.elmg.com |
| Location | Branch |
| Type | |
| Employment | 700 |
| Employment | 133% |
| Change | |
| Sales Range | $100 M-$499.9 M |
| Plant Size | Co. unable to provide |
| Foreign | Export |
| Trade | |
| Year | 1968 |
| Established | |
| Ownership | Public |
| Stock Ticker | ELMGD |
| Top | Mr. Jeff A Leddy-President |
| Executives | Mr. Gerald Hickman-VP Sales/Mktg |
| | Mr. Don T. Scartz-CFO |
| | Mr. Greg Sterns-Pdtn Eng |
| | Mr. J. Grosch-Dir. Operations |
| SIC Code(s) | 3679-Electronic Components, NEC |
| | 3643-Current-Carrying Wiring Devices |
| | 3832-Industrial Instruments for Meas., |
| | Display & Control |

TABLE 4
Hoover's Company Data

| Hoover | |
|---|---|
| Data Field | Hoover Data |
| Gender | Mr. |
| First Name | Paul |
| Last Name | Merolla |
| Suffix | N/A |
| Title | SVP and General |
| | Counsel |
| Company | Instinet Corporation |
| Address | 875 Third Ave |
| | New York, NY |
| | 10022 |
| Phone | 212-310-9500 |
| Fax | 212-759-4016 |
| Exchange | N/A |
| Symbol | N/A |
| Web | www.instinet.com |
| Address | |
| Industry | Investment Banking |
| | & Brokerage |
| Employees | 1,181 |
| % Employee | 8.7% |
| Change | |
| Revenue | $740.3 M |
| ($M) | |
| Revenue | 17.50% |
| Change | |

Using encryption technology such as Secure Sockets Layer (SSL) and Public Key Infrastructure (PKI), secure communication between all participants (i.e. between the salesperson and her Local Sales Leads 51 database at the Sales Office 50, and/or the Central Sales Leads 61 database at the Service Provider 60) via the Internet 56 is used in this invention's preferred embodiment. Furthermore, confidential information stored in the Sales Leads databases 51 and 61 is optionally encrypted as well.

We now return to the description of the preferred embodiment's implementation of the Sales Cycle 1, starting with the Pre-Sale 2.

### Pre-Sale

The salesperson knows which Target Market 2.1 that is of interest. The Leads Generation phase 2.2 of the Sales Cycles involves collating pertinent data from various information databases relevant to a salesperson's Target Market 2.1 into a central Sales Leads database at either a Service Provider 60 (i.e. the Central Sales Leads database 61), or at the salesperson's Sales Office 50, i.e. the Local Sales Leads database 51.

The Sales Office 50 subscribes to the Service Provider 60 to provide a pertinent Sales Lead database, that can be either downloaded and stored locally in the Sales Office's Local Sales Leads database 51, or salespeople can securely (refer to the above section titled Cryptography for Verification, Integrity and Confidentiality for a description on secure access methodologies that the preferred embodiment uses) access the Central Sales Leads database 61 via the Internet 56. To simplify the description of the invention's preferred embodiment, the situation in which the Sales Office 50 downloads the Central Sales Leads database 61 from the Service Provider 10, is described in more detail.

Information stored in the Local Sales Leads database 51 can have additional information stored in it that the Service Provider 60 does not have, e.g. personal contact information about potential sales leads based on telephone conversations with secretaries, etc. at the potential customer's office, i.e. depicted in FIG. 2 as the Sales Lead Location 59. Generally this information is considered confidential by the salesperson. For example, this additional information could include personal information about the sales lead, i.e. details about family members, lunch preferences, quick tempered, etc. This is one of the reasons why the preferred embodiment uses a Local Sales Lead database 51. On the other hand, confidential information can be added to and stored in the Central Sales Leads 61 database using the above described secure technology.

The Sales Office 50 may choose to synchronize the data stored in both the Local Sales Leads 51 database and the Central Sales Leads 61 database. Synchronizing remote databases is a feature available in today's major database vendors' products, e.g. Oracle, and IBM's DB2. One of the advantages of this option is that the Sales Office need not undertake the possible security risk of placing a key database (and server) on the Internet 56, even though it is protected with secure technology.

Because the salesperson will be mobile when executing one of the most important phases in the Sales Cycle 1, i.e. the Initial Touch 3.1, the salesperson needs to have the relevant sales leads data on her person when she is in the field. Today many salespeople use portable computing devices 58 such as a laptop computer or a Personal Digital Assistant (PDA) such a Palm from Palm Inc. Other portable devices such as the amalgamation of a PDA device and a mobile phone, i.e. a Smart Phone, are also appearing in the marketplace. Examples of such a device include Kyocera's QCP 6035 and Motorola's iDEN mobile phones.

### Downloading Sales Leads to a Portable Computing Device

The invention allows the salesperson to download Sales Leads that are being targeted from the Local Sales Leads database 51 to her portable computing device 58. Generally the Local Sales Leads database 51 is implemented as a centrally located database on the Sales Office's Local Area Network (LAN). This allows many salespeople to share information and resources. Various techniques are available to download this information from the database, e.g. the Palm has a cradle that is linked to a USB, or serial port (RS232) on a PC. Wireless communication such as Wi-Fi (IEEE 802.11b) and Bluetooth also enable the downloading of data between the salesperson's PC 2 and her mobile device 58.

Generally a salesperson would download information pertinent to the sales lead that she is about to call on. This information is illustrated in Table 2. A proactive salesperson may download other potential sales leads that she could call on whilst she is on the road. When the salesperson is at the Sales Lead Location 59, pertinent information is available on her portable computing device 58. To illustrate the utility of the preferred embodiment, we shall consider the case in which the salesperson only downloads information pertinent to her current sales call.

We now consider this step in the Sales Cycle, i.e. the Sale 3 step.

### Sale

This is the step that the current invention primarily focuses on, i.e. the Sale 3. At this stage of the Sales Cycle 1 the salesperson has identified a Target Market 2.1 and has generated a list of potential sales leads from either the Local Sales Leads database 51, or from the Central Sales Leads database 61. The preferred embodiment initially uses the Local Sales Leads database 51 at the Sales Office 50, i.e. before the sales person goes calling. The normal process is that the salesperson will schedule a meeting with potential customers (in Table 2 referred to as Key Decision Makers/Executives) in the Target Market 2.1.

The salesperson then goes out in the field to meet with the prospective customer at the Sales Lead Location 59. Finding the way to the Sales Lead Location 59 is not always a simple task. Not all salespeople are as familiar with a sales territory as a taxi driver may be. Books of maps are usually commonplace in a salesperson's toolkit. The invention's preferred embodiment uses Global Positioning System (GPS) navigation. Various vendors offer GPS hardware and software that integrate with portable devices such as laptop computers and PDAs. These vendors include Garmin International, DeLorme, Magellan and Lowrance. By way of example, the invention's preferred embodiment discusses using the DeLorme GPS Earthmate system for computers.

GPS technology provides real-time tracking on a variety of map sources so that the salesperson can always know exactly where she is in relation to the Sales Lead Location 59, or some other reference point. DeLorme offers many software products with GPS capability—all designed to be used with laptop and/or handheld personal computers. The Earthmate GPS receiver connects to a laptop computer and used with Delorme's Street Atlas USA software, enables the salesperson to track her location in real time, anywhere in the US. The Earthmate system is also available for various PDAs, such as the Palm and Compaq's iPAQ.

Before the salesperson leaves the Sales Office 50, she configures the Street Atlas USA software to direct her to her destination at the Sales Lead Location 59. Today the DeLorme software uses either cartographic or text data entry methods to enter the originating and destination points requiring the person using the system to enter data manually. The preferred embodiment of the invention uses latitude and longitude coordinates where available. For example, in the Sales Leads databases address locations are stored with their Latitude and Longitude coordinates, as well as their street addresses (refer to Table 2). The preferred embodiment of the invention automatically configures, i.e. computer-to-computer interaction, the GPS software with the salesperson's destination coordinates, which have been downloaded from the Local Sales Lead 51 database. Manual data entry is eliminated wherever possible in the invention, which reduces the probability of data entry errors.

The preferred embodiment uses an API provided by the GPS software vendor to integrate this destination data entry process. If the salesperson has multiple Sales Lead Locations 59, that she has downloaded, the preferred embodiment prompts the salesperson to select the interested destination location from a list that is presented to her. Note that the Longitude and Latitude coordinates for every location may not be available in the Sales Lead databases 51 and 61 and hence may not downloaded to the salesperson's portable computing device. In this situation, the preferred embodiment transfers the Sales Lead Location 59 street address via the GPS software's API.

### Sales Call

Leaving the Sales Office 50, the salesperson then travels in her car, or by other means such as public transport, etc. Earthmate GPS and the software determine her location and then calculates the best directions to get to her predetermined destination. The DeLorme system uses spoken directions with multimedia laptops, enabling the salesperson to focus on the road, rather than glancing away at a screen for directions.

Once at the Sales Lead Location 59 it sometimes happens that the person whom the salesperson has an appointment with is unavailable and neglected to call her to reschedule. Usually the salesperson would return to the Sales Office 50, or kill time if she has another potential sales lead appointment.

Today the more productive salesperson may go the company listing board in the building of the Sales Lead Location 59, where she is at, and try and locate a possible cold-call sales lead in her Target Market 2.1. This approach is very much a hit-and-miss technique, because even though the salesperson may identify a potential sales lead from the billboard, she does not have any further information that, for example, may be stored in the Central Sales Leads database 61 or Local Sales Leads database 51.

The preferred embodiment solves this problem by allowing the salesperson to connect securely to these databases by means of a wireless network. Various wireless networks are evolving in the marketplace today such as WAP (Wireless Application Protocol), 2.5G and 3G. Even though the preferred embodiment uses wireless networks, it does not exclude the possibility of using wired networks as well. For example, the cancelled sales call's office may allow the salesperson to connect her portable computing device to the company's LAN and hence access the salesperson's Sales Office 50 via the Internet 56.

Either network connection will work. The important factor being that the salesperson remotely and securely accesses the Local Sales Leads 51 database located at her Sales Office 50. On the other hand, the salesperson could also securely access the Central Sales Leads 61 database.

The process of logging on remotely to the salesperson's Sales Leads database is similar whether she is logging onto the Local Sales Leads 51 database at the Sales Office 50, or logging onto the Central Sales Leads 61 database at the Service Provider 60. We shall consider the implementation of accessing the Local Sales Leads 51 database. Using her portable computing device 58, the salesperson connects to the Internet 56 via the wireless network 57. Once connected to the Internet 56, the salesperson selects the Internet address of her Sales Office 50 Remote Access Server 70. Using SSL and other appropriate cryptography methodologies as described in the above section titled Cryptography for Verification, Integrity and Confidentiality, the salesperson logs onto the Local Sales Leads 51 database. When the salesperson logs onto the database 51, her current GPS location 59 is transferred to the program that interfaces the salesperson to the database 51. This Longitude and Latitude information is used by the preferred embodiment to help pinpoint other potential sales leads in the vicinity of the salesperson's current location. The salesperson can now request the following information from the database 51:

All other potential sales leads at her current location 59.

After browsing a list of potential sales leads at her location 59, download a specific set of sales leads (one or many).

All potential sales leads within a specific radius, e.g. 5 minute walk or drive, from her current location 59.

The requested sales leads information (see Table 2) is downloaded to the salesperson's portable computing device 58.

In the advent that the salesperson's portable computing device 58 is unavailable (e.g. it is broken, or there is no network coverage, or the battery is flat, etc.), it is possible that the pertinent sales leads could also be provided to the salesperson via an analog telephone interface. One example of an analog telephone interfaces include the common use of Dual Tone Modulated Frequency (i.e. touch-tone) menu telephone systems (also known as Interactive Voice Response systems). Many patents have been granted to this field of technology including U.S. Pat. No. 6,091,805 to Watson and U.S. Pat. No. 5,615,257 to Pezzullo, et al. Another example of an analog telephone interface is the emerging voice recognition technology. Using this methodology the salesperson would call a specific telephone number, e.g. at the Sales Office 50, identify herself and then vocally request the additionally Sales Leads information.

In these two mentioned analog telephone scenarios, the salesperson would most probably have to write down the additional information that she has retrieved. An article in Communications News, February 2001 titled “Have you heard the news about speech recognition and the hand-held Web?” details the pros and cons of using this methodology. Another possibility, is to request that the information is faxed to a specified telephone number, e.g. at the cancelled sales lead location 59.

Now that the salesperson has more potential Sales Leads in hand, she can now start the Sale 3 process as described above. Note that even if the salesperson simply drops off brochures at the newly identified leads, the 10-3-1 ratio guarantees a return on this “investment”, i.e. increasing the productivity of the salesperson.

What is claimed is:

1. A method of compiling prospective customer data using an online interaction between a salesperson and an information system, comprising:
providing the salesperson with selection of various prospective customer profile databases;
receiving the selections from the salesperson to access the said customer profile databases for salesperson;
collating prospective customer information from the said selected customer profile databases;
storing collated data associated with the said selected customer profile databases;
transferring and storing a portion of the said collated data in a salesperson's portable computing device; and
providing the salesperson with secure access to the collated customer profile database.

2. The method of claim 1, wherein the prospective customer profile database comprise data including customer business name, business type, location, size of business, contact information, key decision makers and executives.

3. The method of claim 2, wherein the location data includes street address and Global Positioning System coordinates.

4. The method of claim 2 wherein the contact information includes telephone numbers, fax numbers, electronic-mail addresses and Internet addresses.

5. The method of claim 1, wherein the said online interaction is by means of a computer located at the salesperson's office, a computer at the location of a service provider, and both said computers connected to the Internet.

6. The method of claim 1, wherein the salesperson's selection of prospective customer profile databases is chosen based on data categories including customer business name, business type, location, size of business, contact information, key decision makers and executives.

7. The method of claim 1, wherein the said storing of collated data is located at the said service provider.

8. The method of claim 1, wherein the said storing of collated data is located at the said salesperson's office.

9. A method of compiling prospective customer data using an online interaction between a salesperson and an information system, comprising:
providing the salesperson with selection of various prospective customer profile databases;
receiving the selections from the salesperson to access the said customer profile databases for salesperson;
collating prospective customer information from the said selected customer profile databases;
storing collated data associated with the said selected customer profile databases;
transferring and storing a portion of the said collated data in a salesperson's portable computing device;
providing the salesperson with secure access to the collated customer profile database; and
remotely accessing said stored collated data.

11. The method of claim 10, wherein said remote access method is by means of wireless communications.

12. The method of claim 10, wherein said remote access method is by means of an Interactive Voice Response communications system.
